(19) United States
(12) Patent Application Publication
(10) Pub. No.: US 2007/0168306 A1
(43) Pub. Date: Jul. 19, 2007

(54) Method and system for feature selection in classification

(76) Inventors: Jonathan Qiang Li, Mountain View, CA (US); David R. Smith, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/334,061

(22) Filed: Jan. 17, 2006

(51) Int. Cl. G06N 3/12; G06F 15/18

(52) U.S. Cl. 706/13

(57) ABSTRACT

Individuals in a population are paired together to produce children. Each individual has a subset of features obtained from a group of features. A genetic algorithm is used to construct combinations or subsets of features in the children. A classification algorithm is then used to evaluate the fitness or cost value of each child. The processes of reproduction and evaluation repeat until the population reaches a given classification level. A different classification algorithm is then applied to the population that reached the given classification level.

### BACKGROUND

In many applications the identity of an element or one or more qualities regarding an element are determined by analyzing a number of features. For example, an unknown chemical sample may be identified or classified by performing a number of tests on the unknown sample and then analyzing the test results to determine the best or closest match to test results for a known chemical. In a manufacturing environment, the quality of a solder joint may be determined by analyzing a number of measurements on the solder joint and comparing the results with ideal or acceptable known measurements.

The test results or measurements typically define the features to be combined and analyzed during the classification process. In many applications, a large number of features are obtained from an unknown element. Combining the large number of features into subsets for analysis can be time consuming due to the large number of combinations.

One technique used to solve the combinatorial problem is a greedy algorithm. A greedy algorithm approximates the best classification by optimizing one feature at a time. For example, in a version of the greedy algorithm known as hill climbing, the algorithm determines the best single feature according to a cost function. When the best single feature is found, the algorithm then attempts to find the second best feature to pair with the first feature. This algorithm continues adding new features until new features will not improve the solution or classification. In some situations, however, the algorithm is not able to determine new features to pair with the current combination, resulting in an inability to determine the best classification for the element.

### SUMMARY

In accordance with the invention, a method and system for feature, selection in classification are provided. Individuals in a population are paired together to produce children. Each individual has a subset of features obtained from a group of features. A genetic algorithm is used to construct combinations or subsets of features in the children. A classification algorithm is then used to evaluate the fitness or cost value of each child. The processes of reproduction and evaluation repeat until the population reaches a given classification level. A different classification algorithm is then applied to the population that reached the given classification level.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a flowchart illustrating a method for feature selection in classification in an embodiment in accordance with the invention;

FIGS. 2A-2B depict a more detailed flowchart of a method for feature selection in classification in an embodiment in accordance with the invention;

FIG. 3 is a flowchart of a method for determining a cost function shown in block 206 of FIG. 2 in an embodiment in accordance with the invention; and

FIG. 4 is a block diagram of a system for implementing the methods of FIG. 1-3 in an embodiment in accordance with the invention.

### DETAILED DESCRIPTION

The following description is presented to enable embodiments of the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown, but is to be accorded the widest scope consistent with the appended claims and with the principles and features described herein.

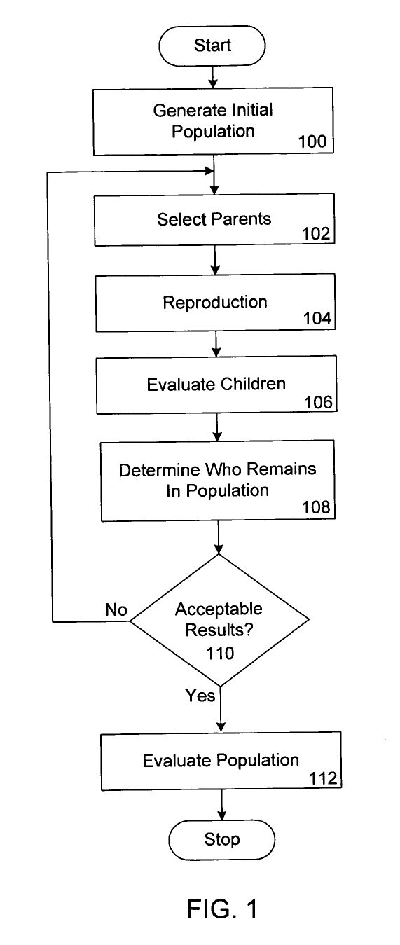

With reference to FIG. 1, there is shown a flowchart illustrating a method for feature selection in classification in an embodiment in accordance with the invention. Initially an initial population is generated, as shown in block 100. Pairs of parents are then created (block 102) and reproduced (block 104). A genetic algorithm is used to construct combinations or subsets of features in the children in an embodiment in accordance with the invention. The children typically receive a portion of their features from one parent and the remaining features from the other parent.

The children are then evaluated at block 106. A classification algorithm is applied to the children to determine the fitness or cost function of each child in an embodiment in accordance with the invention. A cost function evaluates the goodness of the combination of features (i.e., accuracy of the classification) in each child. Determining a cost function includes comparing the combination of features in each child against an ideal or known set of features in an embodiment in accordance with the invention.

The parents and children that will remain the population are then determined at block 108 and a decision made as to whether the population is acceptable (block 110). The population can be acceptable in several ways. For example, in one embodiment in accordance with the invention, the population is acceptable when the population reaches stasis. In another embodiment in accordance with the invention, the population is acceptable when the population reaches a given classification level. The given classification level is determined by a number of factors. By way of example only, the level of accuracy and the amount of time needed to analyze the population and subsequent populations are factors used to determine the given classification level.

The process returns to block 102 when the population is not acceptable. When the population is acceptable, the population is evaluated at block 112. Evaluation of the population includes the application of a different classification algorithm to determine the goodness of the combination of features (i.e., accuracy of the classification) in each individual in the population. The second classification algorithm is used to identify the individual or individuals that meet or exceed a given classification level or have a predetermined minimum cost function. For example, the second classification algorithm determines the individual in the population that best fits or matches an ideal set of features.

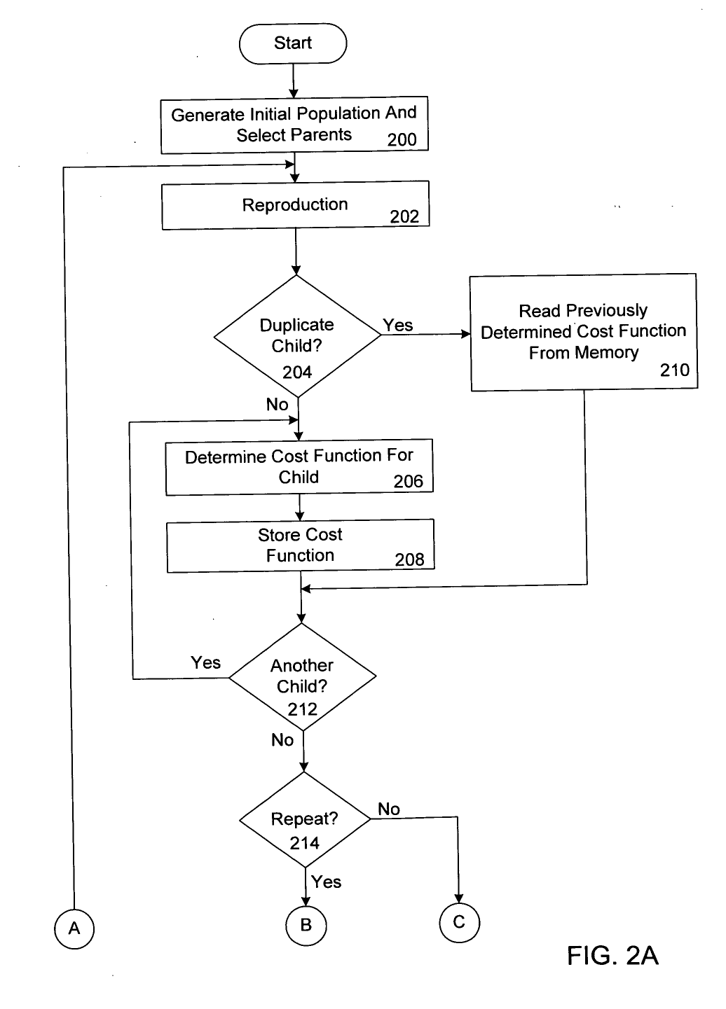

FIGS. 2A-2B depict a more detailed flowchart of a method for feature selection in classification in an embodiment in accordance with the invention. Initially a population that includes a number of individuals is generated, as shown in block 200. The number of individuals in the population is selected such that each feature is represented a predetermined number of times in an embodiment in accordance with the invention. For example, if each feature is to occur five times in the population, then the size of the population (P) is calculated as P=ceil(O*N/I), where O is the number of time each feature is to occur in the population, N is the number of features, and I is the number of features assigned to each individual.

The features assigned to each individual may be assigned randomly or the features may be assigned using random permutations of features. The use of random permutations typically allows all of the features to be fairly represented in the population. In another embodiment in accordance with the invention, the population may be created by assigning some or all of the features in a non-random manner.

Next, at block 202, parents are selected and paired together for reproduction. A genetic algorithm is used to construct combinations or subsets of features in the children. The children receive a portion of their features from one parent and the remaining features from the other parent in an embodiment in accordance with the invention.

Pairs of parents are randomly selected and reproduced in one embodiment in accordance with the invention. In another embodiment in accordance with the invention, one parent is paired with a partner whose selection depends on its fitness relative to the others in the population. The fitness values for one particular parent and its child or children are then evaluated and the fittest of the group is included in the next generation. And in yet another embodiment in accordance with the invention, pairs of parents are selected randomly with the probability of selection for a given individual being proportional to its fitness value.

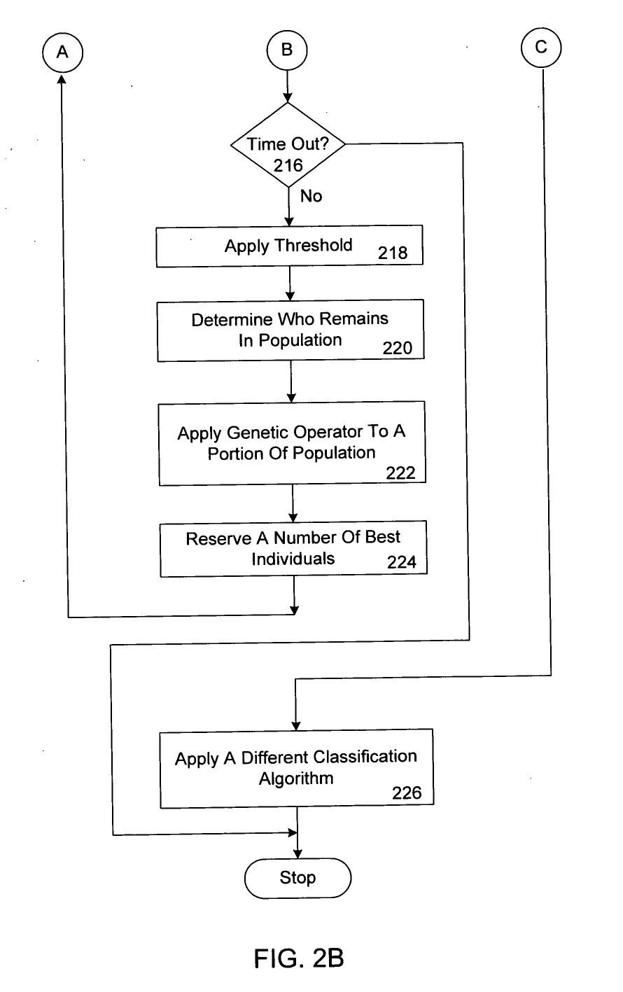

A determination is then made at block 204 as to whether the combination of features in a particular child has been previously evaluated. If not, a cost function for the child is determined and stored in memory (blocks 206, 208). In an embodiment in accordance with the invention, each new combination of features and its corresponding cost function are stored in a lookup table. The cost function may be determined, for example, by performing a Gaussian maximum likelihood classification algorithm in an embodiment in accordance with the invention. The determination of the cost function is described in more detail in conjunction with FIG. 3.

When a child has a duplicate combination of features, the method passes to block 210 where the previously determined cost function is read from memory. The process then continues at block 212 where a determination is made as to whether another child is to be processed. If so, the method returns to block 204 and repeats until a cost function is determined for all the children.

When a cost function is determined for all of the children, a determination is made as to whether the process of reproduction and evaluation is to be repeated (block 214). For example, blocks 206-212 are repeated until the population reaches a stasis in an embodiment in accordance with the invention. In other embodiments in accordance with the invention, blocks 206-212 repeat until the population reaches a given classification level.

If the process is to repeat, a determination is made as to whether the method has timed out (block 216). The method ends if the process has timed out. The process may time out, for example, when the population does not reach stasis or the given classification level in a predetermined amount of time.

If the method has not timed out, the process continues at block 218 where a threshold is applied to the cost functions. The value of the threshold is determined by the application. For example, the threshold is set to select the top ten percent of fitness values in an embodiment in accordance with the invention. In another embodiment in accordance with the invention, the threshold accepts the top fifty fitness values.

Next, at block 220, a determination is made as to which individuals remain in the population. An optional genetic operator may then be applied to a portion of the population, as shown in block 222. The genetic operator may include any known genetic operator, including, but not limited to, mutation, crossover, and insertion. The type of genetic operator used on a population depends on the application.

A number of the best individuals may then be reserved, as shown in block 224. Block 224 is optional and may be done so a relatively accurate classification or subset of features is not accidentally lost as a result of the pairings of individuals. The process then returns to block 202.

Referring again to block 214, when blocks 202-212 are not to be repeated, the method passes to block 226 where a classification algorithm different from the algorithm used at block 206 is applied to the population. In an embodiment in accordance with the invention, a Gaussian maximum likelihood classification algorithm is applied at block 206 and a k nearest neighbor classification algorithm is used at block 226. By way of example only, a 1-nearest neighbor leave-one-out cross-validation method may be applied to the population. The number of misclassifications are accumulated and used as the cost function. Other types of k nearest neighbor techniques or classification algorithms may be used in other embodiments in accordance with the invention.

Embodiments in accordance with the invention are not limited to the blocks and their arrangement shown in FIGS. 2A-2B. Other embodiments in accordance with the invention may include additional blocks or may remove some of the blocks. For example, block 216, block 218, or both may not be implemented in other embodiments in accordance with the invention.

And as discussed above, the first classification algorithm applied to each population is a Gaussian maximum likelihood classification algorithm and the second classification algorithm applied to the population that reached the given classification level is a k nearest neighbor classification algorithm. Embodiments in accordance with the invention, however, are not limited to these two classification algorithms. Other types of classification algorithms may be used, such as, for example, support vector machines (SVM), classification trees, boosted classification trees, and feed-forward multi-layer neural networks.

FIG. 3 is a flowchart of a method for evaluating a cost function shown in block 206 of FIG. 2 in an embodiment in accordance with the invention. Initially the means of all features and the covariance matrix of all of the features are computed and stored in memory (blocks 300, 302). A Gaussian maximum likelihood classification procedure is then applied to the individuals in a population and the means and covariance matrices of each individual are computed. This step is shown in block 304.

The mean and covariance of an individual are sub-arrays of the overall mean and covariance in an embodiment in accordance with the invention. The two likelihood values of each data point are compared with respect to the good and the bad fitted Gaussian densities. The data point is then assigned to the more likely class. The number of misclassifications are accumulated and used as the cost function. In one embodiment in accordance with the invention, the Gaussian maximum likelihood classification reduces the number of individuals to those most likely to be the fittest. For example, in one embodiment in accordance with the invention, the Gaussian maximum likelihood classification algorithm is performed on seventy to one hundred generations. A population typically reaches stasis during 70-100 generations. The k nearest neighbor classification algorithm is then used to make the final selection from the population in stasis.

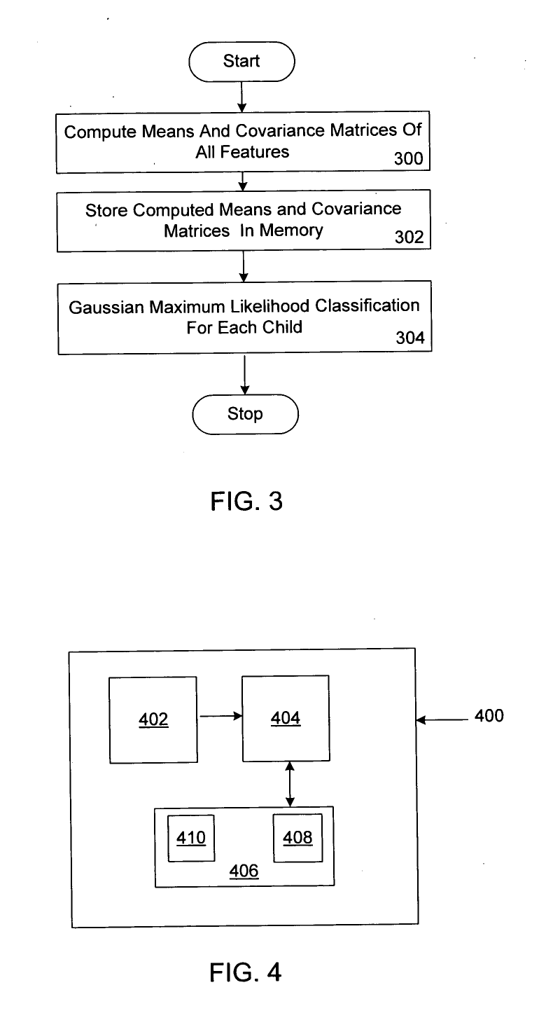

FIG. 4 is a block diagram of a system for implementing the methods of FIG. 1-3 in an embodiment in accordance with the invention. System 400 includes input device 402, processor 404, and memory 406. Input device 402 may be implemented as any type of imager in the embodiment of FIG. 4, including, but not limited to, x-ray or camera imagers. Input device 402 may be used, for example, to capture images of an object, such as a solder joint, component, or circuit board that is undergoing quality assurance testing. Feature selection is used to obtain a test set of features that is subsequently used to determine whether each object meets given quality assurance standards.

In the embodiment of FIG. 4, the test set of features is obtained by analyzing images of an object taken prior to quality assurance testing. After the test image or images are captured by input device 402, processor 404 runs a feature selection algorithm to determine which set of features should be included in the test set of features. For example, the first through tenth moments may be calculated for a number of aspects of an object representing the objects to be tested. In an embodiment in accordance with the invention, the aspects of the object are components on a circuit board.

The moments of the image are calculated as

$${M}_{A} = \frac{1}{n} {\sum }_{i = 1}^{n} {X}_{i}^{A} ,$$

where A is the moment order (e.g., first, second, etc.) and Xᵢ is the image number with i=1, 2, . . . n. The moments are used as a list of potential features. The test set of features may, for example, include three of the ten moments. A feature selection method, such as the method shown in FIG. 1 or FIG. 2, is used to select the three moments included in the test set of features.

Referring again to FIG. 4, memory 406 may be configured as one or more memories, such as read-only memory and random access memory. The test set of features 408 is stored in memory 406. During quality assurance testing, input device 402 captures images of the objects being tested. The same moments used in the test set of features are calculated from captured images and compared with the test set of features to determine whether each object passes the quality assurance tests.

Embodiments in accordance with the invention, however, are not limited in application to the embodiment shown in FIG. 4. Feature selection in classification may be used in a variety of applications, including, but not limited to, quality assurance testing on other types of objects, compounds, or devices, identification of chemical compounds, and inspections during a manufacturing process.

1. A method for feature selection in classification in quality assurance testing, the method comprising:
a) applying a genetic algorithm to a pairs of individuals in a population to produce a generation of children, wherein each child is comprised of a combination of features constructed from a respective pair of individuals; and
b) applying a first classification algorithm to the generation of children to determine a cost function for each child.

2. The method of claim 1, further comprising repeating a) and b) until a present generation of children reaches a given classification level.

3. The method of claim 2, wherein repeating a) and b) until a present generation of children reaches a given classification level comprises repeating a) and b) until a present generation of children reaches stasis.

4. The method of claim 2, further comprising:
c) applying a second classification algorithm to the present generation of children that reached the given classification level.

5. The method of claim 1, wherein applying a first classification algorithm to the generation of children to determine a cost function for each child comprises applying a Gaussian maximum likelihood classification algorithm to the generation of children to determine a cost function for each child.

6. The method of claim 4, wherein applying a second classification algorithm to the present generation of children comprises applying a k nearest neighbor classification algorithm to the present generation of children that reached the given classification level.

7. A method for feature selection in classification for use in quality assurance testing, comprising:
a) creating a generation of children from a population comprised of a first plurality of individuals, wherein each child is comprised of a combination of features constructed from a respective pair of individuals;
b) applying a first classification algorithm to the generation of children to evaluate a cost function for each child;
c) creating a subsequent generation of children differing from the previous generation of children;
d) repeating b) and c) until a present generation of children reaches a given classification level; and
e) when the present generation of children reaches the given classification level, applying a second classification algorithm to the present generation of children.

8. The method of claim 7, further comprising applying one or more genetic operators to a subsequent generation of children.

9. The method of claim 7, further comprising selecting pairs of individuals in the first plurality of individuals by randomly selecting pairs of individuals.

10. The method of claim 7, further comprising selecting pairs of individuals in the first plurality of individuals based on a cost function of each individual relative to the others in the first plurality of individuals.

11. The method of claim 7, wherein applying a first classification algorithm to the generation of children to evaluate a cost function for each child comprises applying a Gaussian maximum likelihood classification algorithm to the generation of children to evaluate a cost function for each child.

12. The method of claim 7, wherein applying a second classification algorithm to the present generation of children comprises applying a k nearest neighbor classification algorithm to the present generation of children that reached the given classification level.

13. The method of claim 7, wherein repeating b) and c) until a present generation of children reaches a given classification level comprises repeating b) and c) until a present generation of children reaches stasis.

14. A system for feature selection in classification for quality assurance testing, comprising:
an input device operable to obtain a plurality of features from an object; and
a processor operable to perform feature selection in classification using the plurality of features, wherein the performance of feature selection in classification includes the application of two classification algorithms.

15. The system of claim 14, further comprising memory for storing one or more known feature sets.

16. The system of claim 15, wherein the processor is operable to apply a genetic algorithm to the plurality of features to produce subsets of features.

17. The system of claim 15, wherein one of the two classification algorithms comprises a Gaussian maximum likelihood classification algorithm.

18. The system of claim 15, wherein one of the two classification algorithms comprises a k nearest neighbor classification algorithm.

19. The system of claim 15, wherein the input device comprises an imager.
